(19) United States
(12) Patent Application Publication
(10) Pub. No.: US 2017/0223301 A1
(43) Pub. Date: Aug. 3, 2017

(54) IMAGE PROCESSING APPARATUS, VOICE ACQUIRING APPARATUS, VOICE RECOGNITION METHOD THEREOF AND VOICE RECOGNITION SYSTEM

(71) Applicant: SAMSUNG ELECTRONICS CO., LTD., Suwon-si (KR)

(72) Inventors: Hyun-kyu YUN, Seoul (KR); Min-sup KIM, Suwon-si (KR); Byung-jo JUN, Seoul (KR)

(73) Assignee: SAMSUNG ELECTRONICS CO., LTD., Suwon-si (KR)

(21) Appl. No.: 15/489,101

(22) Filed: Apr. 17, 2017

Related U.S. Application Data
(63) Continuation of application No. 13/781,819, filed on Mar. 1, 2013.

(30) Foreign Application Priority Data
Apr. 30, 2012 (KR) 10-2012-0045617

(51) Int. Cl. H04N 5/44; H04N 21/4415; H04N 21/422; H04N 21/41; G10L 15/22; G10L 15/18

(52) U.S. Cl. CPC H04N 5/4403; G10L 15/22; G10L 15/1822; H04N 21/42203; H04N 21/4131; H04N 21/4222; H04N 21/4415; G10L 2015/223

(57) ABSTRACT

Disclosed are an image processing apparatus, a voice acquiring apparatus, a voice recognition method and a voice recognition system. The image processing apparatus includes an image processor which processes an image signal, a communication unit which communicates with at least one electronic apparatus, and a controller which includes a voice recognition engine to recognize a voice command, and controls the communication unit to transmit a command to the at least one electronic apparatus corresponding to the voice command recognized by the voice recognition engine.

### CROSS-REFERENCE TO RELATED APPLICATION

This application is a continuation of U.S. patent application Ser. No. 13/781,819, filed Mar. 1, 2013, which claims priority from Korean Patent Application No. 10-2012-0045617, filed on Apr. 30, 2012 in the Korean Intellectual Property Office, the disclosures of which are incorporated herein in their entireties by reference.

### BACKGROUND

Field

Apparatuses and methods consistent with the exemplary embodiments relate to an image processing apparatus, a voice acquiring apparatus, a voice recognition method and a voice recognition system, and more particularly, to an image processing apparatus, a voice acquiring apparatus, a voice recognition method and a voice recognition system which recognize a user's voice.

Description of the Related Art

There is an increased use of an electronic apparatus which has a voice recognition function for recognizing a user's voice. Voice recognition is being actively used by not only PCs and mobile telecommunication devices, but also household appliances such as digital TVs, air conditioners and home theaters.

A voice recognition engine may be necessary to perform the voice recognition function.

However, installing a voice recognition engine in all of the electronic apparatuses which are controlled by voice recognition is not cost-effective and requires a high-performance CPU, causing unnecessary consumption of resources and incurring unnecessary costs.

Furthermore, when an electronic apparatus which is in use fails to perform the voice recognition function, a user may be required to purchase a new electronic apparatus with a voice recognition engine installed therein.

Moreover, unlike a transmitter (remote controller) of a normal TV, a transmitter of other household appliances, such as an air conditioner, which is not frequently used is easy to lose and hard to find.

### SUMMARY

Aspects of the exemplary embodiments may solve the above-described problems associated with conventional voice recognition techniques, and the foregoing and/or other aspects of the exemplary embodiments may be achieved by providing an image processing apparatus including: an image processor which processes an image signal; a communication unit which communicates with at least one electronic apparatus; and a controller which comprises a voice recognition engine to recognize a voice command, and controls the communication unit to transmit a command to the at least one electronic apparatus corresponding to the voice command recognized by the voice recognition engine.

The image processing apparatus may further include a voice acquirer which receives the voice command, and a voice converter which converts the voice command into an electric voice signal, and the voice recognition engine may recognize the electric voice signal.

The communication unit may receive the electric voice signal from a voice acquiring apparatus which receives and converts the voice command into the electric voice signal, and the voice recognition engine may recognize the received electric voice signal.

The controller may control the communication unit to transmit a command corresponding to the recognized voice command to the voice acquiring apparatus.

The voice acquiring apparatus may include a remote controller.

The image processing apparatus may communicate with another voice recognition engine which recognizes the voice command and which resides in a cloud server which is provided external to the image processing apparatus.

The image processing apparatus may further include a display unit which displays an image thereon based on the processed image signal, and the controller may control the display unit to display information of the recognized voice command.

The communication unit may include an infrared (IR) communication unit which performs an IR communication and a wireless communication unit which performs a wireless communication, and the controller may transmit a command corresponding to the recognized voice command through the wireless communication unit.

The foregoing and/or other aspects of the exemplary embodiments may be achieved by providing a voice acquiring apparatus including: a communication unit which communicates with an image processing apparatus comprising a voice recognition function; a voice acquirer which receives a voice command; a voice converter which converts the received voice command into an electric voice signal; and a controller which controls the communication unit to transmit the electric voice signal to the image processing apparatus.

The communication unit may communicate with at least one electronic apparatus, and the controller may receive a command corresponding to the voice command, which is recognized according to a recognition result of the voice recognition function, from the image processing apparatus, and control the communication unit to transmit the received command to the at least one electronic apparatus.

The communication unit may include an IR communication unit which performs an IR communication and a wireless communication unit which performs a wireless communication, and the controller may receive the command corresponding to the recognized voice command through the wireless communication unit and transmit the received command to the at least one electronic apparatus through the IR communication unit.

The voice acquiring apparatus may include at least one of a remote controller, a mobile phone, a portable terminal apparatus, and a microphone transmitter.

The foregoing and/or other aspects of the exemplary embodiments may be achieved by providing a voice recognition method of an image processing apparatus which includes an image processor to process an image signal, the method including: recognizing a voice command; and transmitting a command to an electronic apparatus corresponding to the recognized voice command.

The method may further include receiving the voice command, and converting the received voice command into an electric voice signal, wherein the recognizing of the voice command includes recognizing the voice command based on the electric voice signal.

The method may further include receiving an electric voice signal which is converted by a voice acquiring apparatus which receives and converts a user's voice command into the electric voice signal, and the recognizing of the user's voice command may include recognizing the voice command based on the received electric voice signal.

The transmitting of the command to an electronic apparatus may include transmitting the command to the voice acquiring apparatus corresponding to the recognized voice command.

The voice acquiring apparatus may include a remote controller.

The method may further include displaying information of the recognized voice command.

The foregoing and/or other aspects of the exemplary embodiments may be achieved by providing a voice recognition system including: a voice acquiring apparatus which receives and converts a voice command into an electric voice signal and transmits the electric voice signal to an image processing apparatus; the image processing apparatus which includes an image processor to process an image signal and a voice recognition engine to recognize the voice command corresponding to the electric voice signal transmitted by the voice acquiring apparatus, and transmits a command to an electronic apparatus corresponding to the voice command recognized by the voice recognition engine; and the electronic apparatus which performs an operation corresponding to the command transmitted from the image processing apparatus.

The foregoing and/or other aspects of the exemplary embodiments may be achieved by providing a voice recognition system including: an image processing apparatus which includes an image processor to process an image signal and a voice recognition engine to recognize a voice command, and receives the voice command and converts the voice command into an electric voice signal, and transmits a command to an electronic apparatus corresponding to the voice command recognized by the voice recognition engine; and the electronic apparatus which performs an operation corresponding to the command from the image processing apparatus.

The voice recognition system may include a voice acquiring apparatus which receives and converts a user's voice command into an electric voice signal, transmits the electric voice signal to the image processing apparatus, receives a command from the image processing apparatus corresponding to the recognized voice command and transmits the received command to the electronic apparatus, and the electronic apparatus may perform an operation corresponding to the command transmitted from the voice acquiring apparatus.

The foregoing and/or other aspects of the exemplary embodiments may be achieved by providing an electronic apparatus including: a communication unit which communicates with an image processing apparatus comprising a voice recognition engine; and a controller which controls the electronic apparatus according to a command which is generated based on a recognition result of the voice recognition engine and received from the image processing apparatus via the communication unit.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 illustrates an example of a voice recognition system according to a first exemplary embodiment;

FIG. 2 is a block diagram of a voice recognition system according to an exemplary embodiment relating to the exemplary embodiment in FIG. 1;

FIG. 3 is a block diagram of a voice recognition system according to another exemplary embodiment relating to the exemplary embodiment in FIG. 1;

FIG. 4 is a block diagram of a voice recognition system according to another exemplary embodiment relating to the exemplary embodiment in FIG. 1;

FIG. 5 illustrates an example of a voice recognition system according to a second exemplary embodiment;

FIG. 6 is a block diagram of a voice recognition system according to another exemplary embodiment relating to the exemplary embodiment in FIG. 5;

FIG. 7 is a block diagram of a voice recognition system according to another exemplary embodiment relating to the exemplary embodiment in FIG. 5; and

FIG. 8 is a flowchart of a voice recognition method of the voice recognition system according to an exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

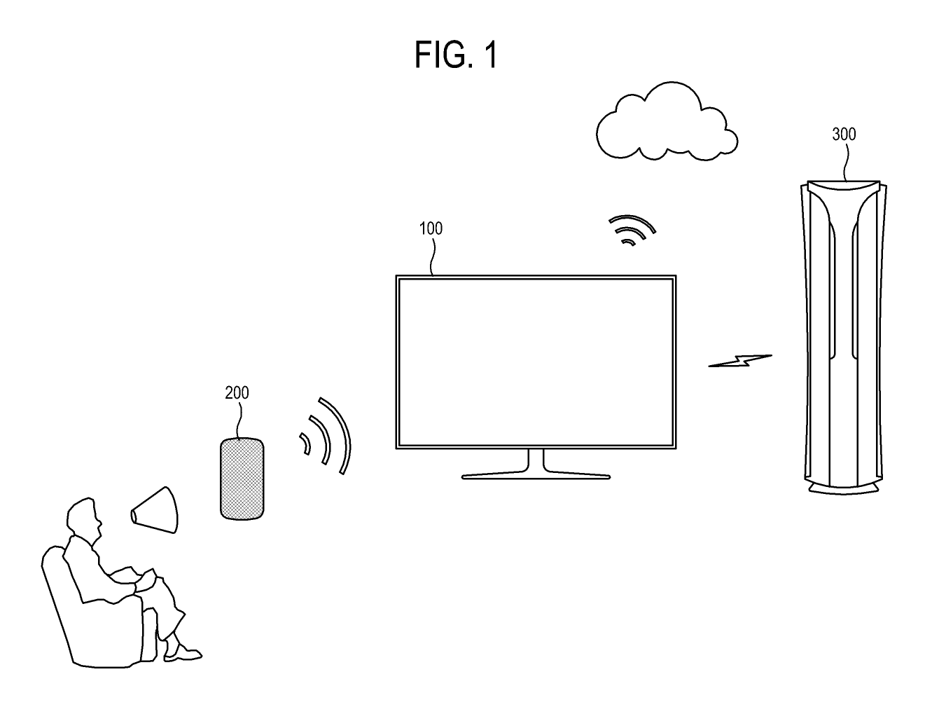

FIG. 1 illustrates an example of a voice recognition system according to a first exemplary embodiment.

As shown therein, the voice recognition system according to the first exemplary embodiment includes an image processing apparatus 100, a voice acquiring apparatus 200 and an electronic apparatus 300. The image processing apparatus 100, the voice acquiring apparatus 200 and the electronic apparatus 300 are connected with each other for communication.

The image processing apparatus 100 processes an image signal, which is supplied by an external image supply source (not shown), according to a preset image processing operation to display an image based on the processed image signal.

The image processing apparatus 100 of the voice recognition system according to the present exemplary embodiment is realized as a TV or a set-top box which processes a broadcasting image based on broadcasting signals/broadcasting information/broadcasting data transmitted by transmission equipment of a broadcasting station. However, other exemplary embodiments are not limited to the foregoing embodiment of the image processing apparatus 100, and the image processing apparatus 100 may be implemented as various other types of apparatuses which may process an image.

The type of an image which is displayable by the image processing apparatus 100 is not limited to the broadcasting image, and may include a video, a still image, applications, on screen display (OSD), a graphic user interface (GUI) to control various operations based on signals/data transmitted by external various image sources (not shown), etc.

The image processing apparatus 100 according to the exemplary embodiment may be realized as a smart TV. The smart TV may receive and display a broadcasting signal in real-time, and with its web browser function, may simultaneously display a broadcasting signal and search and use various contents on the Internet, and provide a convenient user environment. The smart TV includes an open software platform and provides interactive services for a user. Accordingly, the smart TV may provide a user with various contents, e.g., an application with a predetermined service, through the open software platform. According to an exemplary embodiment, the application is an application program providing various types of services, including social networking services (SNS), finance, news, weather, map, music, movies, games, e-books services, etc.

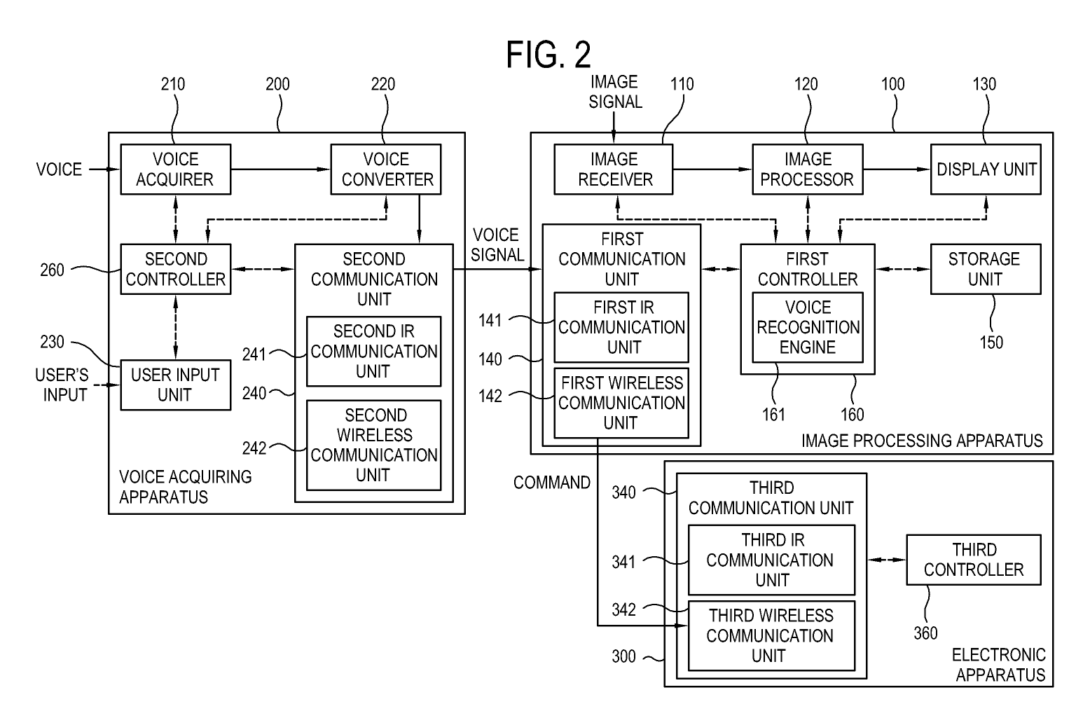

The image processing apparatus 100 according to the present exemplary embodiment includes a voice recognition engine 161 (refer to FIG. 2) which recognizes a user's voice. The image processing apparatus 100 transmits a command, e.g., a control command, to the electronic apparatus 300 corresponding to the recognized voice. Throughout the specification, the term “voice” may refer to a voice command, e.g., a command spoken by a user to control at least one electronic device.

The voice acquiring apparatus 200 receives the user's voice, converts the voice into an electric voice signal and transmits the voice signal to the image processing apparatus 100.

The voice acquiring apparatus 200 is an external apparatus which may perform wireless communication with the image processing apparatus 100, and the wireless communication includes, for example, infrared (IR) communication, radio frequency (RF) communication, Bluetooth, Zigbee, etc. Alternatively, the voice acquiring apparatus 200 may communicate with the image processing apparatus 100 via a wired connection, a combination of wired and wireless connections, etc.

The voice acquiring apparatus 200 according to the present exemplary embodiment is realized as a remote controller. The remote controller transmits a preset command to a corresponding device according to a user's manipulation. The remote controller according to the present exemplary embodiment may be set to transmit a command to the image processing apparatus 100 or the electronic apparatus 300, and as the case may be, may be realized as an integrated remote controller to transmit a command to a plurality of apparatuses. The voice recognition system may include a plurality of voice acquiring apparatuses 200 (e.g., a TV remote controller and an air conditioner remote controller). The voice which is input through the voice acquiring apparatus 200 may include both a voice for controlling the image processing apparatus 100 and a voice for controlling the electronic apparatus 300.

The voice acquiring apparatus 200 according to exemplary embodiments may vary, and may be implemented in many different types of electronic devices, including not only a remote controller, but also, for example, a mobile phone, a portable terminal device, a microphone transmitter, or other electronic devices capable of detecting a user's voice.

The electronic apparatus 300 performs an operation corresponding to a command transmitted by the image processing apparatus 100. The electronic apparatus 300 according to the present exemplary embodiment includes an air conditioner, but is not limited thereto. Alternatively, the electronic apparatus 300 may include other various electronic apparatuses such as a home theater, a radio, a VCR, a DVD, a washing machine, a refrigerator, etc., which may communicate in a wireless manner.

The voice recognition system may include a plurality of electronic apparatuses 300, each of which may receive and operate according to a command transmitted by the image processing apparatus 100.

FIG. 2 is a block diagram of a voice recognition system according to an exemplary embodiment relating to the first exemplary embodiment shown in FIG. 1.

As shown therein, the image processing apparatus 100 processes an image signal, which is supplied by an external image supply source (not shown), according to a preset image processing operation, and displays an image based on the processed image signal.

The image processing apparatus 100 according to the present exemplary embodiment is realized as a TV which displays a broadcasting image based on broadcasting signals/broadcasting information/broadcasting data transmitted by transmission equipment of a broadcasting station. However, other exemplary embodiments are not limited to the foregoing embodiment of the image processing apparatus 100, and the image processing apparatus 100 may be implemented as various other devices, such as a set-top box, a monitor, etc., which processes an image.

The type of an image which is displayable by the image processing apparatus 100 is not limited to the broadcasting image, and may include a video, a still image, applications, an on screen display (OSD), a graphic user interface (GUI; hereinafter, also called a user interface (UI)) to control various operations based on signals/data transmitted by external various image sources, etc.

As shown in FIG. 2, the image processing apparatus 100 includes an image receiver 110 which receives an image signal, an image processor 120 which processes an image signal received by the image receiver 110, a display unit 130 which displays an image thereon based on an image signal processed by the image processor 120, a first communication unit 140 which communicates with an external apparatus, a storage unit 150 which stores therein various types of data, and a first controller 160 which controls the image processing apparatus 100.

The image receiver 110 receives an image signal and transmits the image signal to the image processor 120, and may vary depending on a standard of a received image signal and the embodiment type of the image processing apparatus 100. For example, the image receiver 110 may receive an RF signal from a broadcasting station (not shown) in a wireless manner, or an image signal according to composite video, component video, super video, SCART, or high definition multimedia interface (HDMI) standards in a wired manner. When an image signal includes a broadcasting signal, the image receiver 110 includes a tuner to tune a broadcasting signal by channel.

The image signal may be input by an external apparatus, e.g., a PC, an AV device, a smart phone, a smart pad, etc. The image signal may result from data transmitted through a network such as the Internet. In this case, the image processing apparatus 100 may perform a network communication through the first communication unit 140, or further include an additional network communication unit. The image signal may result from data stored in a non-volatile storage unit 150 such as a flash memory, a hard disc, etc. The storage unit 150 may be provided within/outside the image processing apparatus 100, and if provided outside the image processing apparatus 100, the storage unit 150 may further include a connection unit (not shown) to which the storage unit 150 is connected.

The image processor 120 performs various preset image processing operations on an image signal. The image processor 120 outputs the processed image signal to the display unit 130, on which an image is displayed.

The image processing operation of the image processor 120 may include a decoding operation corresponding to various image formats, a de-interlacing operation, a frame refresh rate conversion operation, a scaling operation, a noise reduction operation for improving an image quality, a detail enhancement operation, a line scanning operation, etc. The image processor 120 may be realized as a group of individual elements performing the foregoing operations individually, or as a system-on-chip which integrates several functions, or in other ways known to those skilled in the art.

The display unit 130 displays an image thereon based on an image signal processed by the image processor 120. The display unit 130 may be realized as various types of display panels, including, for example, liquid crystal, plasma, light-emitting diode (LED), organic light-emitting diode (OLED), surface-conduction electron-emitter, carbon nano-tube, and nano-crystal, but is not limited thereto.

The display unit 130 may further include additional elements according to its embodiment type. For example, when the display unit 130 includes liquid crystal, the display unit 130 also includes an LCD panel (not shown), a backlight unit (not shown) emitting light to the LCD panel, and a panel driving substrate (not shown) driving the panel.

The display unit 130 according to exemplary embodiments may display voice recognition results as information of the recognized voice. The voice recognition results may be displayed in various forms, such as text, graphic, icon, etc., and the text form may include various different types of characters, including, for example, letters and numbers. A user may identify whether the voice has been correctly recognized through the voice recognition results displayed on the display unit 130. A user may manipulate a user input unit 230 of a remote controller and select information corresponding to a user's voice among the displayed information.

The first communication unit 140 communicates with the voice acquiring apparatus 200 and the electronic apparatus 300. The first communication unit 140 according to the present exemplary embodiment includes a first IR communication unit 141 performing an IR communication, and a first wireless communication unit 142 performing interactive wireless communication. In an exemplary embodiment, the interactive wireless communication includes at least one of RF, Zigbee and Bluetooth, although is not limited thereto according to other exemplary embodiments.

The first IR communication unit 141 and the first wireless communication unit 142 may receive various commands and signals from the voice acquiring apparatus 200 which may be implemented as a remote controller, and may transmit such commands and signals to the first controller 160. The signals which are transmitted by the voice acquiring apparatus 200 include a converted electric voice signal.

The first wireless communication unit 142 transmits a command (command code) to the electronic apparatus 300 corresponding to the recognized voice.

The storage unit 150 stores therein various types of data according to a control of the first controller 160. In an exemplary embodiment, the storage unit 150 is realized as a non-volatile storage medium such as a flash memory or a hard disc drive, although is not limited thereto according to other exemplary embodiments. The storage unit 150 is accessed by the first controller 160, and the data are read and/or recorded and/or amended and/or deleted and/or updated by the first controller 160.

The data which are stored in the storage unit 150 may include an operating system (OS) for driving the image processing apparatus 100, other various applications which are executed on the OS, image data and additional data.

The storage unit 150 according to the present exemplary embodiment may store therein various types of data for recognizing a user's voice. For example, the storage unit 150 may store therein voice recognition target information corresponding to the received voice signal.

The first controller 160 performs a control operation for various elements of the image processing apparatus 100. For example, the first controller 160 controls the image processor 120 to perform an image processing operation, and performs a control operation corresponding to a command from a remote controller to thereby control overall operations of the image processing apparatus 100.

The first controller 160 may be realized as a central processing unit (CPU) which is combined with software.

The first controller 160 includes a voice recognition engine 161 which recognizes a user's voice. The voice recognition function of the voice recognition engine 161 may be performed by a known voice recognition algorithm. For example, the voice recognition engine 161 may extract a voice distinction vector of a voice signal, and compare the extracted voice distinction vector with the voice recognition target information stored in the storage unit 150 to recognize the voice. When the extracted voice distinction vector is not consistent with the voice recognition target information stored in the storage unit 150, the voice recognition engine 161 may adjust the voice recognition result with highly similar information to recognize the voice. When there is a plurality of highly similar information, the first controller 160 may display a plurality of information on the display unit 130 to enable a user to select one of the pieces of information.

The voice recognition engine 161 according to the present exemplary embodiment includes a voice recognition engine which is embedded in the CPU, but is not limited thereto. For example, the voice recognition engine 161 may include a device built in the image processing apparatus 100, e.g., an additional chip such as a microcomputer.

The first controller 160 performs an operation corresponding to the recognition result of the voice recognition engine 161. For example, when the image processing apparatus 100 is implemented as a TV, upon recognition of a voice command such as, for example, “volume up”, “volume down”, “increase volume, or “decrease volume” by the voice recognition engine 161 while a user watches a program, such as a movie or news, the first controller 160 may accordingly adjust the volume of the movie or news.

When it is recognized by the voice recognition engine 160 that the recognized voice is a voice command for controlling the electronic apparatus 300, the first controller 160 controls the first communication unit 140 to transmit a command to the electronic apparatus 300 corresponding to the recognized voice.

For example, when the voice recognition engine 161 recognizes the voice command “raise temperature”, the first controller 160 recognizes this voice command as the voice command for controlling an air conditioner and controls the first communication unit 140 to transmit a command to the electronic apparatus 300 corresponding to the air conditioner to thereby raise the temperature of the air conditioner. The voice commands which are recognizable by the voice recognition engine 161 include not only “raise temperature”, but also may other different types of commands, such as, for example, “stop operation/stop”, “semitropical climate”, “air-conditioning operation/air-conditioning”, “dehumidification operation/dehumidification”, “heating operation/heating”, “strong wind”, “moderate wind”, “gentle wind”, “reduce temperature” and variations of these commands, as well as other various types of control commands for the air conditioner.

The first controller 160 may distinguish a first voice command for controlling the image processing apparatus 100 and a second voice command for controlling the electronic apparatus 300 by comparison with the voice recognition target information stored in the storage unit 150.

The first controller 160 may distinguish the first voice command for controlling the image processing apparatus 100 and the second voice command for controlling the electronic apparatus 300 according to the voice acquiring apparatus 200 which transmits a voice signal. For example, a voice signal transmitted by a TV remote controller may be identified as the first voice command for controlling the image processing apparatus 100, and a voice signal transmitted by an air conditioner remote controller may be distinguished as the second voice command for controlling the electronic apparatus 300, e.g., the air conditioner. In this case, a voice signal transmitted by the voice acquiring apparatus 200 includes identification information of a controlled apparatus.

In an exemplary embodiment, a command which is transmitted through the first communication unit 140 is a preset control signal including the identification information of the electronic apparatus 300 as the controlled apparatus.

Hereinafter, a detailed configuration of the voice acquiring apparatus 200 will be described.

As shown in FIG. 2, the voice acquiring apparatus 200 includes a voice acquirer 210 which receives a user's voice, a voice converter 220 which converts the input voice into an electric voice signal, a user input unit 230 which receives a user's manipulation, a second communication unit 240 which communicates with an external apparatus, and a second controller 260 which controls the voice acquiring apparatus 200.

The voice acquirer 210 receives a user's voice and may be realized as a microphone.

The voice converter 220 converts a voice, which is input by the voice acquirer 210, into an electric voice signal. In an exemplary embodiment, a converted voice signal has a pulse code modulation (PCM) or compressed audio waveform. The voice converter 220 may include an A/D converter which converts a user's voice into a digital signal.

Alternatively, when the voice acquirer 210 includes a digital microphone, the voice acquirer 210 does not need an additional A/D converter and thus may include the voice converter 220 integrated therein.

The user input unit 230 transmits various preset control commands or various types of information to the second controller 260 by a user's manipulation and input. The user input unit 230 may include buttons including menu keys and number keys provided in an external side of the voice acquiring apparatus 200. When the voice acquiring apparatus 200 includes a TV remote controller, the user input unit 230 may further include a touch sensor to sense a user's touch input, and a motion sensor to sense a motion of the voice acquiring apparatus 200.

The second communication unit 240 communicates with the image processing apparatus 100 and the electronic apparatus 300. The second communication unit 240 according to the present exemplary embodiment includes a second IR communication unit 241 which performs an IR communication.

The second IR communication unit 241 transmits various control commands according to a user's manipulation of the user input unit 230 to a corresponding electronic apparatus, e.g., the image processing apparatus 100 or the electronic apparatus 300.

The second IR communication unit 241 according to the present exemplary embodiment may transmit a voice signal which has been converted from the user's voice input through the voice acquirer 210, to the image processing apparatus 100. When the voice acquiring apparatus 200 is plurally provided, e.g., provided as a TV remote controller and an air conditioner remote controller, the transmitted voice signal may include identification information of the voice acquiring apparatus 200, or identification information of the electronic apparatus 300, as the controlled apparatus.

The second communication unit 240 according to the present exemplary embodiment may include a second wireless communication unit 242 which performs interactive wireless communication. In an exemplary embodiment, the interactive wireless communication includes at least one of RF, Zigbee, and Bluetooth, although is not limited thereto and may be implemented according to other types of wireless communication according to other exemplary embodiments.

The second controller 260 performs a control operation for various elements of the voice acquiring apparatus 200. For example, the second controller 260 may generate a command corresponding to a user's manipulation of the user input unit 230, and control the second communication unit 140 to transmit the generated command to the image processing apparatus 100 or the electronic apparatus 300.

The second controller 260 may include a micro controller unit (MCU) which is combined with software, although is not limited thereto.

Upon input of a user's voice through the voice acquirer 210, the second controller 260 according to the present exemplary embodiment controls the voice converter 220 to convert the voice into an electric voice signal, and controls the second communication unit 240 to transmit the converted voice signal to the image processing apparatus 100.

In an exemplary embodiment, when the voice acquiring apparatus 200 is plurally provided, e.g., provided as a TV remote controller and an air conditioner remote controller, the second controller 260 may transmit the voice signal with identification information of the voice acquiring apparatus 200 added thereto, or identification information of the electronic apparatus 300 as the controlled apparatus added thereto, to the image processing apparatus 100. The image processing apparatus 100 identifies the electronic apparatus 300 as the controlled apparatus by using the identification information included in the voice signal, and transmits a command to the corresponding electronic apparatus 300.

The electronic apparatus 300 receives a control command from the image processing apparatus 100, and performs an operation corresponding to the received command.

As shown in FIG. 2, the electronic apparatus 300 includes a third communication unit 340 which communicates with an external apparatus, and a third controller 360 which controls operations of the electronic apparatus 300.

The third communication unit 340 includes a third wireless communication unit 342 corresponding to the first wireless communication unit 142 of the image processing apparatus 100. The third wireless communication unit 342 may, for example, correspond to at least one of RF, Zigbee, and Bluetooth as a type of interactive wireless communication. The third communication unit 340 may further include a third IR communication unit 341 which receives a control signal from a remote controller.

For example, when the electronic apparatus 300 is an air conditioner and the image processing apparatus 100 recognizes a user's voice command “raise temperature” and transmits a corresponding command through the first wireless communication unit 142, the third controller 360 receives the command through the third wireless communication unit 342 and raises the temperature of the air conditioner.

The command which is transmitted to the electronic apparatus 300 may include not only the “raise temperature” voice command, but also many other different types of voice commands corresponding to control operations performed by the air conditioner, and may further include commands for controlling various types of electronic apparatuses 300, such as an air conditioner, radio, home theater, VCR, DVD, washing machine, refrigerator, etc.

According to the exemplary embodiment in FIG. 2, upon input of a user's voice, the voice acquiring apparatus 200 converts the voice into a voice signal and transmits the voice signal to the image processing apparatus 100 through one of the second IR communication unit 241 and the second wireless communication unit 242. The image processing apparatus 100 transmits a command corresponding to the voice recognized by the voice recognition engine 161 with respect to the received voice signal, to the electronic apparatus 300 through the first wireless communication unit 142. The electronic apparatus 300 receives a command from the image processing apparatus 100 through the third wireless communication unit 342, and performs an operation corresponding to the received command.

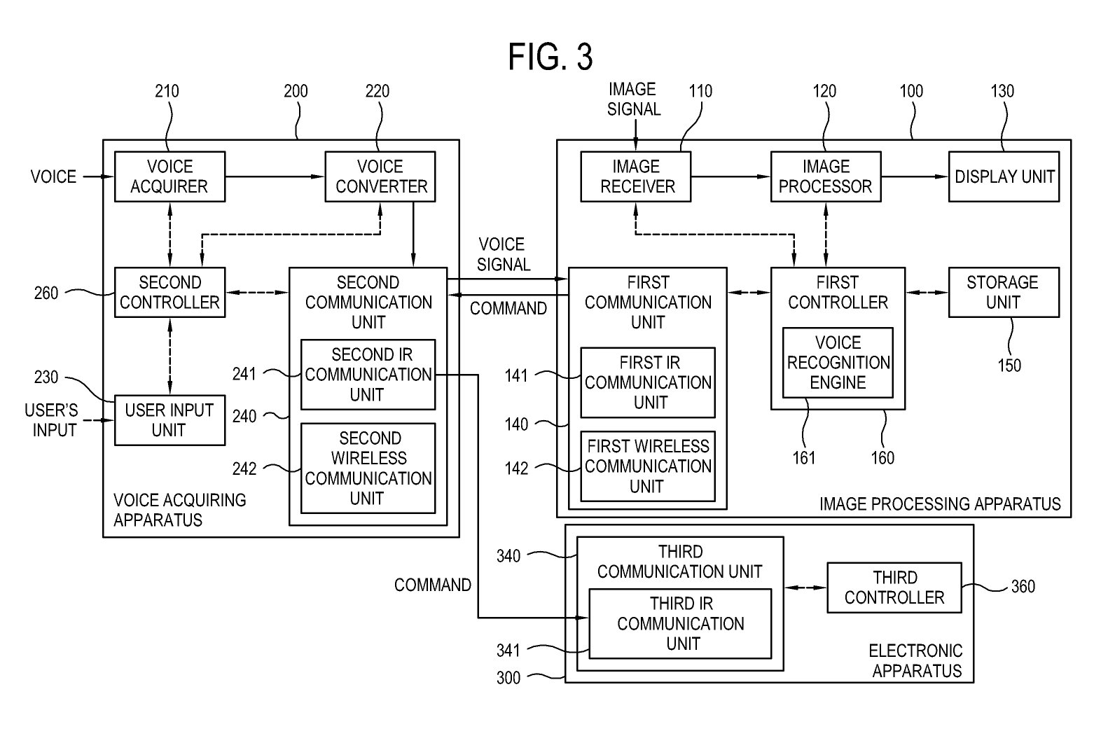

FIG. 3 is a block diagram of a voice recognition system according to another exemplary embodiment relating to the exemplary embodiment in FIG. 1.

Unlike the voice recognition system according to the exemplary embodiment in FIG. 2, in the voice recognition system according to the exemplary embodiment in FIG. 3, the image processing apparatus 100 transmits a command to the voice acquiring apparatus 200 corresponding to the recognized voice and the voice acquiring apparatus 200 transmits the received command to the electronic apparatus 300. Elements of the exemplary embodiment in FIG. 3 have the same reference numerals and names as those of the exemplary embodiment in FIG. 2. To avoid repetitive description, these elements will not be described in detail.

The third communication unit 340 of the electronic apparatus 300 according to the exemplary embodiment in FIG. 3 includes a third IR communication unit 341 to perform IR communication, but does not include a communication module for interactive wireless communication.

The exemplary embodiment in FIG. 3 may apply to various situations. For example, the exemplary embodiment in FIG. 3 may apply to the situation when the electronic apparatus 300 is implemented as an older model of a remote controller which uses IR communication, in which case the electronic apparatus 300 may receive a command by an IR signal through the remote controller.

According to the exemplary embodiment in FIG. 3, when a user's voice is input, the voice acquiring apparatus 200 converts the voice into a voice signal and transmits the voice signal to the image processing apparatus 100 through one of the second IR communication unit 241 and the second wireless communication unit 242. The image processing apparatus 100 transmits a command corresponding to the voice recognized by the voice recognition engine 161 with respect to the received voice signal, to the voice acquiring apparatus 200 through the first wireless communication unit 142. The voice acquiring apparatus 200 receives the command from the image processing apparatus 100 through the second wireless communication unit 242, and transmits the received command to the electronic apparatus 300 through the second IR communication unit 241. The electronic apparatus 300 receives the command from the voice acquiring apparatus 200 through the third IR communication unit 341, and performs an operation corresponding to the received command.

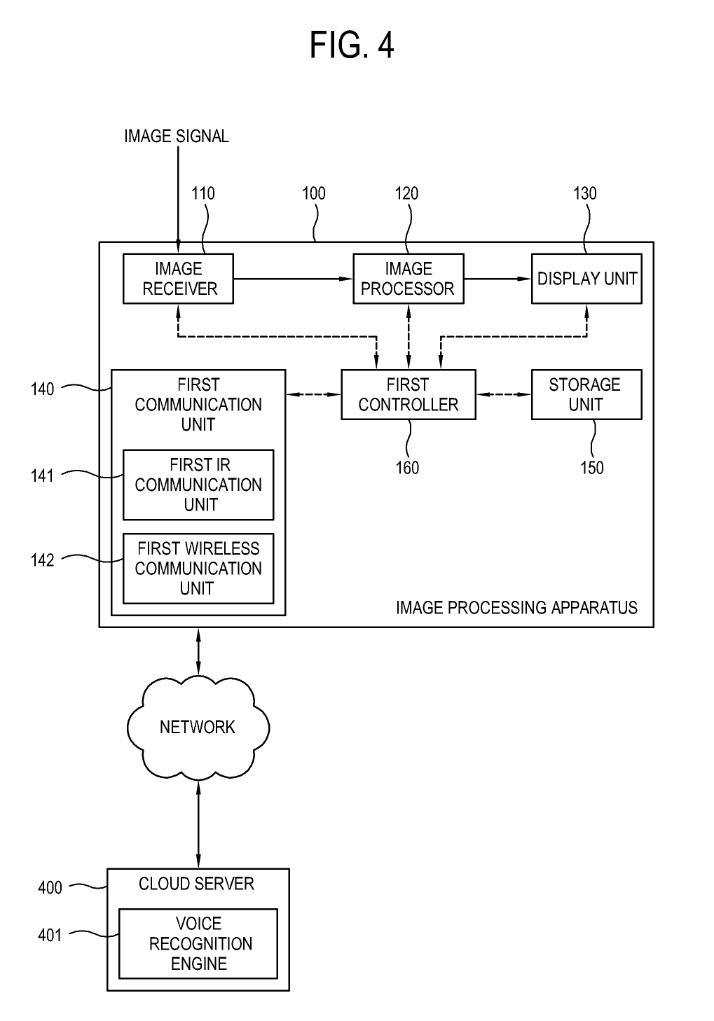

FIG. 4 is a block diagram of a voice recognition system according to another exemplary embodiment relating to the first exemplary embodiment in FIG. 1.

Unlike the voice recognition system according to the exemplary embodiment in FIG. 3, in the voice recognition system according to the exemplary embodiment in FIG. 4, a voice recognition engine 401 is included in a cloud server 400 which is provided outside the image processing apparatus 100. Except for the cloud server 400 and the voice recognition engine 401, elements of the exemplary embodiment in FIG. 4 have the same reference numerals and names as those in the exemplary embodiments in FIGS. 2 and 3. To avoid repetitive description, these elements will not be described in detail.

The cloud server 400 according to the exemplary embodiment in FIG. 4 communicates with the image processing apparatus 100 through a network such as, for example, the Internet. The network may include a combination of networks, including a wired and/or wireless network.

The voice recognition function of the voice recognition engine 401 may be performed by a known voice recognition algorithm, and this function is the same as that explained in FIG. 2. Thus, a detailed explanation will be omitted.

The voice recognition engine 401 according to the present exemplary embodiment may include a voice recognition engine which is embedded in the CPU of the cloud server 400 or a device built in the cloud server 400, e.g., an additional chip such as a microcomputer.

According to the exemplary embodiment in FIG. 4, in a first example, upon input of a user's voice, the voice acquiring apparatus 200 converts the voice into a voice signal and transmits the voice signal to the image processing apparatus 100, and the image processing apparatus 100 transmits the received voice signal to the cloud server 400. The cloud server 400 transmits the voice recognition result of the voice recognition engine 401 to the image processing apparatus 200. The image processing apparatus 100 transmits a command corresponding to the recognized voice according to the received voice recognition result to the electronic apparatus 300, and the electronic apparatus 300 performs an operation corresponding to the command transmitted by the image processing apparatus 100.

According to another exemplary embodiment in FIG. 4, in a second example, upon input of a user's voice, the voice acquiring apparatus 200 converts the voice into a voice signal and transmits the voice signal to the image processing apparatus 100 through one of the second IR communication unit 241 and the second wireless communication unit 242, and the image processing apparatus 100 transmits the received voice signal to the cloud server 400. The cloud server 400 transmits the voice recognition result of the voice recognition engine 401 to the image processing apparatus 200. The image processing apparatus 100 transmits a command corresponding to the recognized voice according to the received voice recognition result, to the voice acquiring apparatus 200 through the first wireless communication unit 142. The voice acquiring apparatus 200 receives the command from the image processing apparatus 100 through the second wireless communication unit 242, and transmits the received command to the electronic apparatus 300 through the second IR communication unit 241. The electronic apparatus 300 receives the command from the voice acquiring apparatus 200 through the third IR communication unit 341 and performs an operation corresponding to the received command.

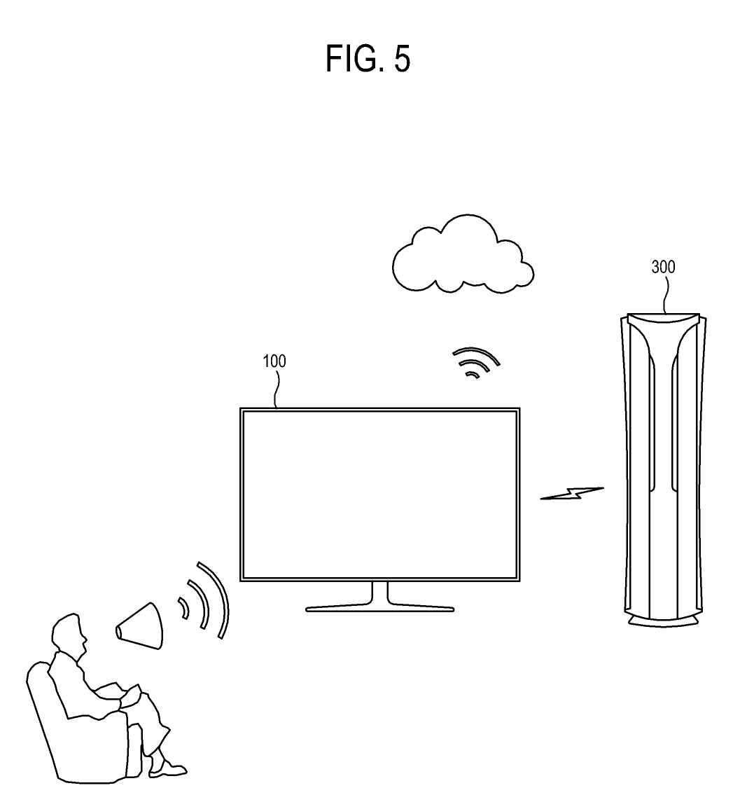

FIG. 5 illustrates an example of a voice recognition system according to a second exemplary embodiment.

The voice recognition system according to the second exemplary embodiment in FIG. 5 has the image processing apparatus 100 including voice acquisition and conversion elements which are not included in the voice recognition system in FIG. 1. Thus, the voice recognition system according to the second exemplary embodiment does not have an additional voice recognition apparatus 200, and the image processing apparatus 100 acquires, converts and recognizes voice.

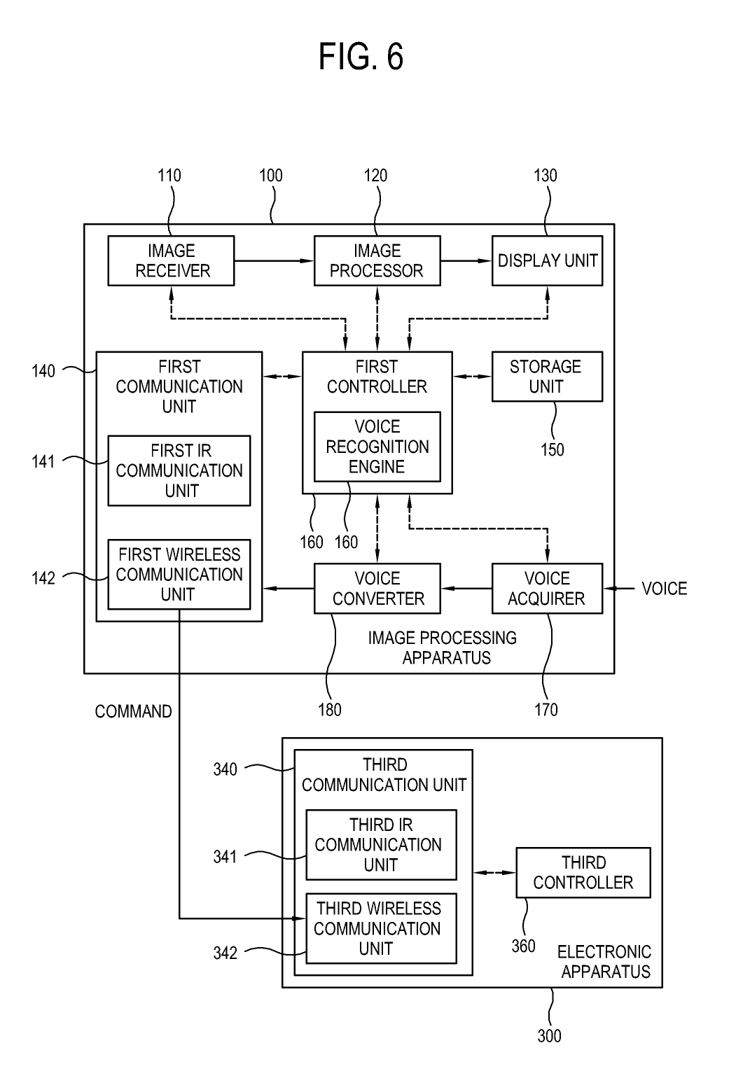

FIG. 6 is a block diagram of a voice recognition system according to the exemplary embodiment in FIG. 5. Unlike the exemplary embodiment in FIG. 2, the voice recognition system in FIG. 6 has the image processing apparatus 100 that includes a voice acquirer 170 and a voice converter 180. Elements other than the voice acquirer 170 and the voice converter 180 have the same reference numerals and names as those in the exemplary embodiment in FIG. 2. To avoid repetitive description, these elements will not be described in detail.

The voice acquirer 170 receives a user's voice and may include a microphone.

The voice converter 180 converts a voice input by the voice acquirer 170, into an electric voice signal. In an exemplary embodiment, the converted voice signal has a PCM or compressed audio waveform, although is not limited thereto. The voice converter 180 may include an A/D converter to convert a user's voice into a digital signal.

Alternatively, when the voice acquirer 170 includes a digital microphone, the voice acquirer does not need an additional A/D converter and may therefore include the voice converter 180 integrated therein.

As a first example, when a user's voice is input through the voice acquirer 170, the first controller 160 of the image processing apparatus 100 according to the exemplary embodiment in FIG. 6 controls the voice converter 180 to convert the voice into an electric voice signal. When the electric voice signal is recognized by the voice recognition engine 160 as a voice for controlling the electronic apparatus 300, the first controller 160 transmits the command corresponding to the recognized voice to the electronic apparatus 300 through the first wireless communication unit 142. The electronic apparatus 300 receives the command from the image processing apparatus 200 through the third wireless communication unit 342, and performs an operation corresponding to the received command.

As a second example, upon input of a user's voice, the first controller 160 of the image processing apparatus 100 according to another exemplary embodiment in FIG. 6 controls the voice converter 180 to convert the voice into an electric voice signal. When the electric voice signal is recognized by the voice recognition engine 160 as a voice for controlling the electronic apparatus 300, the first controller 160 may transmit the command corresponding to the recognized voice to a remote controller of the electronic apparatus 300 (e.g., a remote controller of an air conditioner) through the first wireless communication unit 142.

The remote controller may transmit the received command to the electronic apparatus 300 through the IR communication unit. The electronic apparatus 300 may receive the command from the remote controller through the third IR communication unit 341, and perform an operation corresponding to the received command.

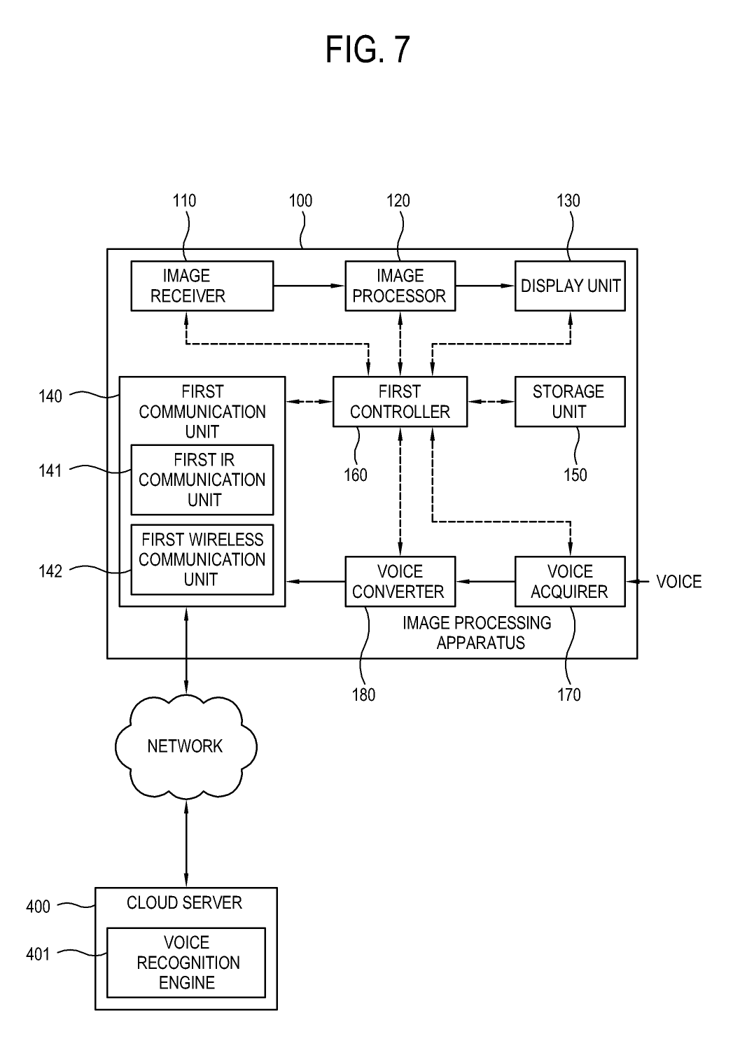

FIG. 7 is a block diagram of a voice recognition system according to another exemplary embodiment relating to the second exemplary embodiment in FIG. 5.

Unlike the voice recognition system according to the exemplary embodiment in FIG. 6, in the voice recognition system according to the exemplary embodiment in FIG. 7, the voice recognition engine 401 is included in the cloud server 400 provided external to the image processing apparatus 100. Elements other than the cloud server 400 and the voice recognition engine 401 have the same reference numerals and names as those in the exemplary embodiment in FIG. 6. To avoid repetitive description, these elements will not be described in detail.

Like the exemplary embodiment in FIG. 4, the cloud server 400 according to the exemplary embodiment in FIG. 7 communicates with the image processing apparatus 100 through a network such as the Internet. The network may include a combination of networks, such as a wired and/or wireless network.

The voice recognition function of the voice recognition engine 401 may be performed by a known voice recognition algorithm, and this function is the same as that explained in FIG. 2. Thus, a detailed explanation will be omitted.

The voice recognition engine 401 according to the present exemplary embodiment includes a voice recognition engine which is embedded in the CPU of the cloud server 400 or a device built in the cloud server 400, e.g., an additional chip such as a microcomputer.

According to the exemplary embodiment in FIG. 7, upon input of a user's voice through the voice acquirer 170, the first controller 160 of the image processing apparatus 100 controls the voice converter 180 to convert the voice into a voice signal. The image processing apparatus 100 transmits the converted voice signal to the cloud server 400. The cloud server 400 transmits the voice recognition result of the voice recognition engine 401 to the image processing apparatus 100. The image processing apparatus 100 transmits a command corresponding to the recognized voice according to the received voice recognition result to the electronic apparatus 300 through the first wireless communication unit 142. The electronic apparatus 300 receives the command from the image processing apparatus 100 through the third wireless communication unit 342, and performs an operation corresponding to the received command.

Hereinafter, a voice recognition method of the voice recognition system according to an exemplary embodiment will be described with reference to accompanying drawings.

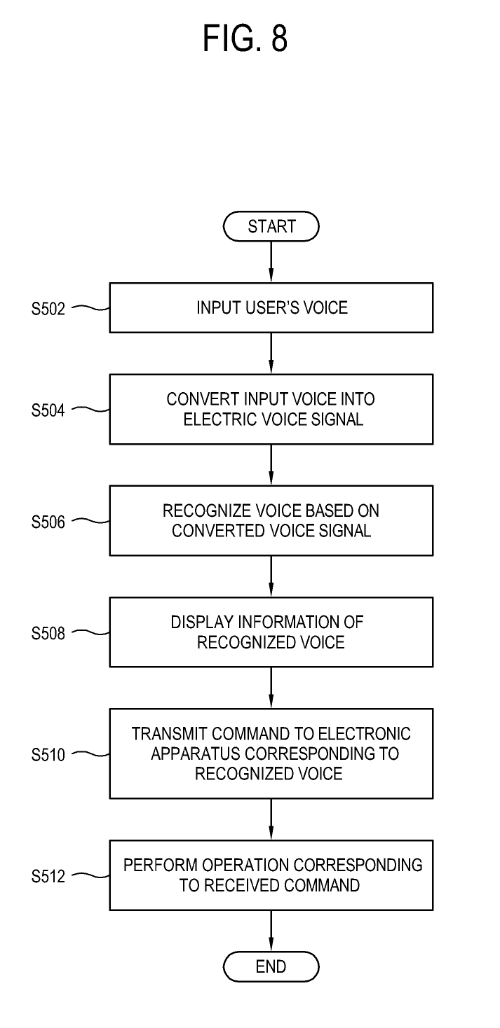

FIG. 8 is a flowchart of a voice recognition method of a voice recognition system according to an exemplary embodiment. In the following description of FIG. 8, references are made to certain elements of the exemplary embodiments shown in FIGS. 1 to 7. However, these references to certain elements of the exemplary embodiments in FIGS. 1 to 7 are examples only, and it is understood that the operations of FIG. 8 may be performed by other elements which are not shown in FIGS. 1 to 7.

As shown in FIG. 8, the voice recognition system according to the exemplary embodiment receives a user's voice through the voice acquirer 210 of the voice acquiring apparatus 200 or the voice acquirer 170 of the image processing apparatus 100 at operation S502.

The user's voice input at operation S502 is converted into an electric voice signal by the voice converter 220 of the voice acquiring apparatus 200 or the voice converter 180 of the image processing apparatus 100 at operation S504.

The image processing apparatus 100 recognizes the voice corresponding to the voice signal converted at operation S504 through the voice recognition engine 161 embedded in the first controller 160 or the voice recognition engine 401 of the cloud server 400 at operation S506. When the voice recognition engine 401 of the cloud server 400 is used, the operation S506 may include an operation of transmitting the voice signal by the image processing apparatus 100 to the cloud server 400 and receiving the voice recognition result at the image processing apparatus 100 from the cloud server 400.

The image processing apparatus 100 may display the information of the voice recognized at operation S506 on the display unit 130 at operation S508. When there is a plurality of voice recognition results, the first controller 160 may display a plurality of information on the display unit 130 to enable a user to select one of the voice recognition results.

The image processing apparatus 100 transmits the command corresponding to the voice recognized at operation S506 (or selected at operation S508) to the electronic apparatus 300 at operation S510. When the electronic apparatus 300 includes the third IR communication unit 341 which performs an IR communication, the operation S510 may include an operation of transmitting the command by the image processing apparatus 100 to the voice acquiring apparatus 200 corresponding to the recognized voice, and an operation of transmitting the received command by the voice acquiring apparatus 200 to the electronic apparatus 300.

The electronic apparatus 300 performs an operation corresponding to the command received at operation S510 at operation S512.

According to the exemplary embodiments, the voice recognition engines 161 and 401 recognize a voice, and an echo system in which a command corresponding to a recognition result is transmitted to the electronic apparatus 300 as the controlled apparatus employs the voice recognition to thereby improve the entire voice recognition system.

According to the exemplary embodiments, a voice recognition engine which requires a high-performance CPU does not need to be provided in all of the electronic apparatuses, thereby preventing unnecessary consumption of resources and costs.

Furthermore, since the image processing apparatus, in which a user may immediately identify the voice recognition results, may perform the voice recognition function, a user's convenience improves and voice recognition errors may be reduced.

Moreover, even when the electronic apparatus which is in use does not perform the voice recognition function, such a function may be performed by utilizing existing resources such as the image processing apparatus 100.

Also, when a transmitter (e.g., remote controller) of an electronic apparatus which is not used frequently, such as an air conditioner remote controller, is lost, the electronic apparatus may be controlled by voice recognition.

Although a few exemplary embodiments have been shown and described, it will be appreciated by those skilled in the art that changes may be made in these exemplary embodiments without departing from the principles and spirit of the exemplary embodiments, the range of which is defined in the appended claims and their equivalents.

What is claimed is:

1. An image processing apparatus comprising:
a display;
an image processor configured to process an image signal;
a communicator configured to communicate with at least one electronic apparatus and a voice acquiring apparatus; and
a controller configured to:
control the display to display an image,
in response to receiving a voice signal including a voice command from the voice acquiring apparatus, perform an operation regarding a voice recognition process on the received voice signal to recognize the received voice command, and
control the communicator to transmit a command corresponding to the recognized voice command to an electronic apparatus among the at least one electronic apparatus via the voice acquiring apparatus.

2. The image processing apparatus according to claim 1,
wherein the controller is configured to:
perform an operation corresponding to the recognized voice command in response to the recognized voice command being a command for controlling the image processing apparatus, and
control the communicator to transmit the command corresponding to the recognized voice command to the electronic apparatus in response to the recognized voice command being a command for controlling the electronic apparatus.

3. The image processing apparatus according to claim 1,
wherein the communicator is further configured to communicate with a server which performs a voice recognition process, and
wherein the controller is configured to transmit the received voice signal to the server and receive a recognized voice command corresponding to the voice signal.

4. The image processing apparatus according to claim 1,
wherein the communicator comprises a wireless communicator which performs a wireless communication, and the controller is configured to transmit the command to the voice acquiring apparatus via the wireless communication.

5. The image processing apparatus according to claim 1, wherein the voice acquiring apparatus comprises a remote controller.

6. The image processing apparatus according to claim 1, wherein the controller controls the display to display information of the recognized voice command.

7. The image processing apparatus according to claim 1, wherein the controller controls the communicator to transmit a code corresponding to the recognized voice command to the voice acquiring apparatus so that the voice acquiring apparatus transmits a signal based on the code to an electronic apparatus corresponding to the recognized voice command among the at least one electronic apparatus.

8. The image processing apparatus according to claim 1, wherein the image processing apparatus comprising a storage configured to store a data for recognizing the voice command which corresponds to a registered electronic apparatus.

9. The image processing apparatus according to claim 7, wherein the controller downloads the data for recognizing the voice command from a server.

10. A voice recognition method of an image processing apparatus, the method comprising:
displaying an image;
in response to receiving a voice signal including a voice command from a voice acquiring apparatus, performing an operation regarding a voice recognition process on the received voice signal to recognize the voice command; and
transmitting a command corresponding to the recognized voice command to an electronic apparatus via the voice acquiring apparatus.

11. The method according to claim 10, further comprising:
performing an operation corresponding to the recognized voice command in response to the recognized voice command being a command for controlling the image processing apparatus; and
transmitting the command corresponding to the recognized voice command to the electronic apparatus in response to the recognized voice command being a command for controlling the electronic apparatus.

12. The method according to claim 10, further comprising transmitting the received voice signal to a server which perform a voice recognition process, and receiving the recognized voice command corresponding to the voice signal.

13. The method according to claim 10, further comprising transmitting the command to the voice acquiring apparatus via a wireless communication.

14. The method according to claim 10, further comprising displaying information of the recognized voice command.

15. The method according to claim 10, further comprising transmitting a code corresponding to the recognized voice command to the voice acquiring apparatus so that the voice acquiring apparatus transmits a signal based on the code to an electronic apparatus corresponding to the recognized voice command among at least one electronic apparatus.

16. The method according to claim 10, further comprising storing a data for recognizing the voice command which corresponds to a registered electronic apparatus.

17. The method according to claim 16, further comprising downloading the data for recognizing the voice command from a server.

18. A voice recognition system comprising a voice acquiring apparatus and an image processing apparatus which communicates with at least one electronic apparatus,
wherein the image processing apparatus is configured to:
in response to receiving a voice signal including a voice command from a voice acquiring apparatus, perform an operation regarding a voice recognition process on the received voice signal to recognize the received voice command; and
transmit a command corresponding to the recognized voice command to the voice acquiring apparatus;
and wherein the voice acquiring apparatus is configured to transmit the command corresponding to the recognized voice command to an electronic apparatus among the at least one electronic apparatus.

19. The system according to claim 18,
wherein the image processing apparatus is configured to:
perform an operation corresponding to the recognized voice command in response to the recognized voice command being a command for controlling the image processing apparatus, and
transmit the command corresponding to the recognized voice command to the electronic apparatus in response to the recognized voice command being a command for controlling the electronic apparatus.

20. The system according to claim 18,
wherein the image processing apparatus is configured to transmit the command to the voice acquiring apparatus via the wireless communication, and
the voice acquiring apparatus is configured to transmit the command to the electronic apparatus via an infrared (IR) communication.

21. The system according to claim 18,
wherein the image processing apparatus is configured to transmit the received voice signal to a server which perform a voice recognition process, and receive a recognized voice command corresponding to the voice signal.

22. The system according to claim 18,
wherein the image processing apparatus is configured to transmit a code corresponding to the recognized voice command to the voice acquiring apparatus, and
the voice acquiring apparatus is configured to transmit a signal based on the code to an electronic apparatus corresponding to the recognized voice command among the at least one electronic apparatus.

23. The system according to claim 18,
wherein the image processing apparatus is configured to store a data for recognizing the voice command which corresponds to a registered electronic apparatus.

24. The system according to claim 23,
wherein the image processing apparatus is configured to download the data for recognizing the voice command from a server.
